(19) United States
(12) Patent Application Publication
(10) Pub. No.: US 2014/0245967 A1
(43) Pub. Date: Sep. 4, 2014

(54) Tooth ball

(71) Applicant: Kenneth Glaser, Bakersfield, CA (US)

(72) Inventor: Kenneth Glaser, Bakersfield, CA (US)

(21) Appl. No.: 13/815,439

(22) Filed: Mar. 4, 2013

(51) Int. Cl. A01K 11/00; A01K 13/00

(52) U.S. Cl. CPC A01K 15/026; A01K 13/001
USPC 119/709

(57) ABSTRACT

The Tooth Ball having a hollow natural leather colored ball with holes throughout also has a powdery substance that mixes with the pets saliva which produces a paste that releases in to the attached bristles and cleans the pets teeth and massages the gums leaving a very clean mouth for the pet.

There is no federally sponsored or research or development associated with this application.

There is no joint research agreement associated with this application.

### BACKGROUND OF THE INVENTION

(1) Field of the Invention

The Tooth Ball is a new design and utility functionality for a pets chew toy that brushes the teeth.

(2) Description of the Art Including Information Disclosed Under 37 CFR 1.97 & 1.98

The art described in the drawings of the design and utility function illustrate the unique ability of the invention to brush a pets teeth while enjoying the chew toy.

### BRIEF SUMMARY OF THE INVENTION

The Tooth Ball is a rubber ball with holes and bristles that brush the pets teeth.

### BRIEF DESCRIPTION OF THE SEVERAL VIEWS OF THE DRAWINGS

There are 3 drawings in total that describe and illustrate the design and function of the Tooth Ball.

FIG. 1: is the Tooth Ball view as the entire invention.

FIG. 2: is the Tooth Ball view showing the skin with holes.

FIG. 3: is the Tooth Ball showing the inside view.

### DETAILED DESCRIPTION OF THE PREFERRED EMBODIMENT

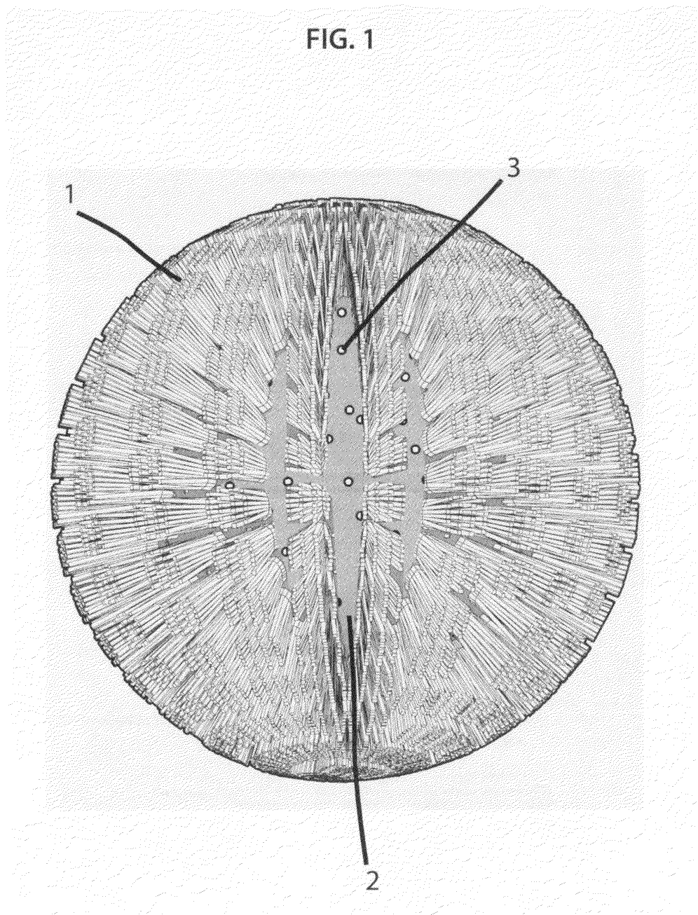

FIG. 1: In illustration #1 shows the bristles that are attached to the #2 the skin of the tooth ball with #3 the hole and holes piercing the surface of the skin.

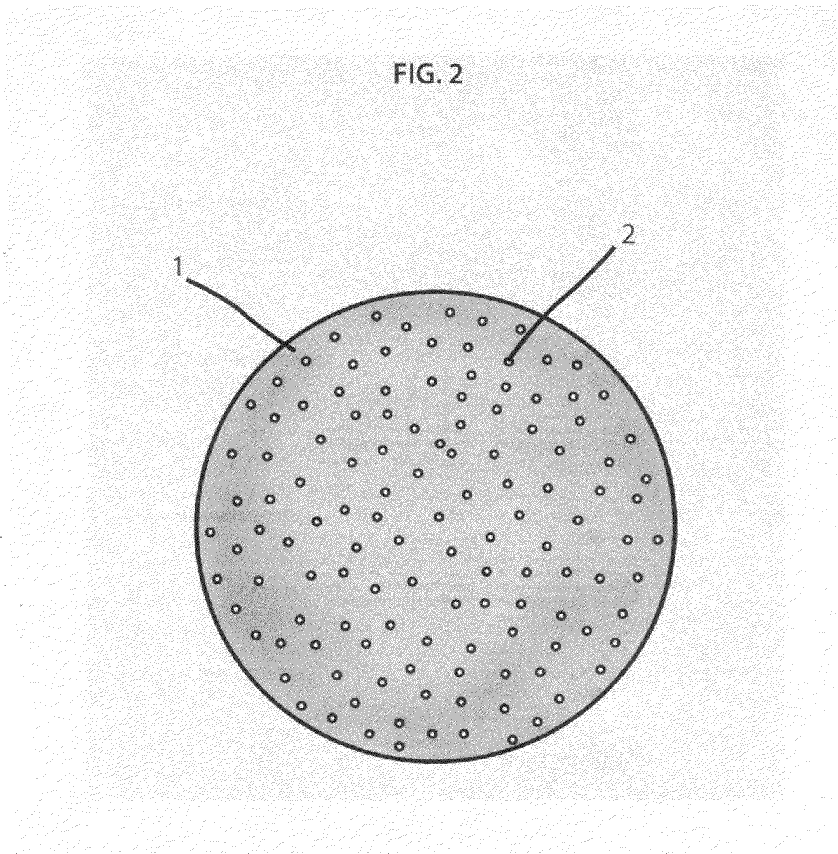

FIG. 2: In illustration #1 shows the surface of the skin of the tooth ball with #2 the hole and holes piercing the skin of the tooth ball.

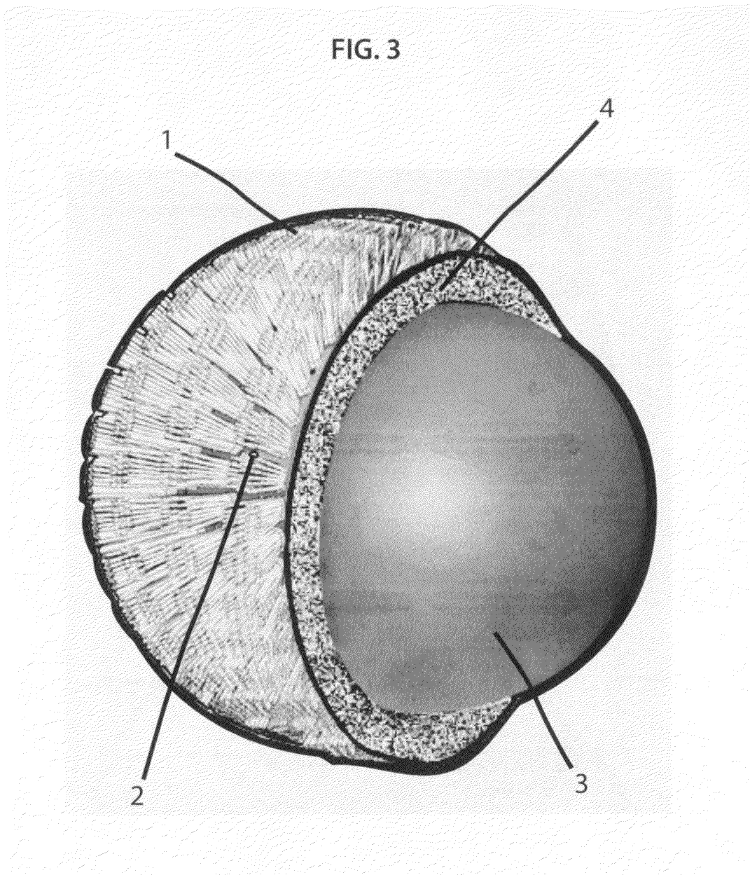

FIG. 3: In illustration #1 shows the bristles as the brushing portion of the tooth ball with #2 the skin of the tooth ball with #3 the center solid portion of the tooth ball with #4 the granular substance between the skin and center of the tooth ball.

### DETAILED DESCRIPTION OF THE INVENTION

The Tooth Ball is a new chew toy for pets that has a natural leather colored hollow ball with holes throughout the ball. Inside the ball is a granular substance that mixes with the pets saliva and becomes a paste much like a toothpaste that releases into the bristles attached to the ball and while the pet is chewing the ball it is cleaning the teeth and massaging the gums.

What is claimed is:

1: The bristles attached to the tough skin of the acting as a tooth brush for pets.

2: The granular substance inside between the skin and solid center of the ball acting as a tooth paste for the pet.

3: The center solid ball that allows the granular substance to easily permeate the skin with the holes to transfer the substance into a paste that permeates the bristles that brush the pets teeth.
